(19) United States
(12) Patent Application Publication
(10) Pub. No.: US 2015/0119224 A1
(43) Pub. Date: Apr. 30, 2015

(54) System For Producing Packaging Cushioning And Supply Structure Therefor

(71) Applicant: Sealed Air Corporation (US), Duncan, SC (US)

(72) Inventors: Thomas P. Orsini, Sterling, MA (US); Kostadin I. Kostadinov, Billerica, MA (US); Atul Arora, Piscataway, NJ (US)

(73) Assignee: Sealed Air Corporation (US), Duncan, SC (US)

(21) Appl. No.: 14/061,888

(22) Filed: Oct. 24, 2013

(51) Int. Cl. B31D 5/00; B65H 1/28

(52) U.S. Cl. CPC B31D 5/0043; B65H 1/28
USPC 493/464

(57) ABSTRACT

A supply structure for a supply of fan-folded sheet stock material, which is positionable relative to a cushion conversion machine to provide thereto the fan-folded sheet stock material for conversion thereof into packaging cushioning. The supply structure includes two or more supports, each of the supports including a base and a riser extending upwardly from the base. The base and the riser are structured and arranged to cooperatively accommodate a stack of the fan-folded sheet stock material.

### BACKGROUND OF THE INVENTION

The present invention relates generally to packaging cushioning and, more specifically, to a system and supply structure for producing packaging cushioning from fan-folded sheet stock material, such as paper.

Machines for producing packaging cushioning from sheet stock material are well-known in the art. Such machines generally operate by pulling a web of paper from a roll, manipulating the paper web in such a way as to convert the paper into packaging cushioning, and then severing the cushioning into cut sections of a desired length. While such machines are widely used and have been commercially successful, certain drawbacks exist. For example, paper rolls tend to be quite heavy and cumbersome to lift and load onto cushion conversion machines. Further, the shape of paper rolls limits the amount of paper supply that can be stored on a machine and shipped in a delivery truck. Moreover, because of the inertial aspects of a rotating roll, coupled with a constantly-changing unwind-force requirement due to a reduction in the diameter of the roll as it is depleted, relatively sophisticated web handling devices are needed in order to control the tension in the paper web and prevent tearing thereof.

An alternative to the use of paper in roll form is paper or other type of stock material that has been ‘fan-folded’ and formed into a stack. A fan-folded stack of sheet stock material is a web thereof, which generally has a series of alternating, transverse folds that form a sequence of superimposed sheets joined together by the folds, such that the web can be assembled into a relatively compact configuration and arranged as a stack. The web is generally fed into the cushion conversion machine from the top of the stack, whereby the top-most sheets on the stack are sequentially pulled into the machine.

One means for employing fan-folded sheet stock material is to supply the material to the conversion machine from a box. However, in order to fulfill the goal of making the sheet stock material supply relatively light and easy to handle (in comparison with paper rolls), the amount of material contained in each box must generally be limited such that frequent replacement of depleted boxes is required for continuous or semi-continuous use of the machine.

Another approach is to stack individual bundles of fan-folded material on top of one another to form a relatively large stack, with the bottom-most sheet of one bundle being joined, e.g., via two-sided adhesive tape or the like, to the top-most sheet of an adjacent bundle immediately below. In this manner, a relatively large supply of fan-folded material may be formed from several, e.g., four or five, relatively light bundles. In order to support such a stack, i.e., to ensure the stability thereof, e.g., by preventing it from toppling over, and to maintain the stack in an aligned position to properly feed the fan-folded material to the machine, a supply structure is generally employed. Current supply structures are time-consuming and labor-intensive to load. First, the bundle must be deployed from its container, e.g., cardboard box, or other containment system, e.g., baling straps. Next, adhesive strips or other means to connect the bundle to an adjacent bundle in the stack must be prepared. Then, the bundle must be lifted and manipulated in order to insert it into the supply structure and place it on the stack. This process must be repeated for each bundle that is added to the stack.

With conventional fan-fold conversion systems, the above-described loading process generally requires that the cushion conversion machine be stopped for an extended period of time when the supply of fan-folded sheet stock material becomes depleted, which adds a degree of inefficiency to the cushion-making/packaging process.

Accordingly, there is a need in the art for a cushion-conversion system for producing packaging cushioning from fan-folded sheet-stock material, which allows for more efficient loading and re-supply of the fan-folded material.

### SUMMARY OF THE INVENTION

That need is met by the present invention, a first aspect of which is directed to a supply structure for a supply of fan-folded sheet stock material, the supply structure being positionable relative to a cushion conversion machine to provide thereto the fan-folded sheet stock material for conversion thereof into packaging cushioning, the supply structure including two or more supports, each of the supports comprising a base and a riser extending upwardly from the base, the base and the riser being structured and arranged to cooperatively accommodate a stack of the fan-folded sheet stock material.

Another aspect of the invention is directed to a system for producing packaging cushioning comprising, in combination, a cushion conversion machine and a supply structure as described above.

These and other aspects and features of the invention may be better understood with reference to the following description and accompanying drawings.

### BRIEF DESCRIPTION OF THE DRAWING

FIG. 1 is a perspective view of a system for producing packaging cushioning in accordance with the present invention, which includes a cushion conversion machine and a supply structure for a stack of fan-folded sheet stock material;

FIG. 2 is a perspective view of the system of FIG. 1, taken from the rear of the system to show the supply structure;

FIG. 3 is similar to FIG. 2, except that the stack of fan-folded sheet stock material has been removed to show the details of the supply structure;

FIG. 4 is similar to FIG. 2, wherein the fan-folded sheet stock material is prepared to be fed from the top of the stack and into the cushion conversion machine;

FIG. 5 is a side elevational view of the system as shown in FIG. 4;

FIG. 6 is similar to FIG. 5, except that a component of the supply structure (lateral support 56a) has been removed in order to show the stack in the supply structure;

FIG. 7 is a schematic representation of the system as shown in FIGS. 5-6, in order to better show the various angles between the structural components of the system;

FIG. 8A is a perspective view of an alternative system for producing packaging cushioning in accordance with the present invention, in which the supply structure includes two discrete supports for two separate stacks of fan-folded sheet stock material;

FIG. 8B is similar to FIG. 8A, except taken at a 180° offset from the view shown in FIG. 8A to show the rear of the system;

FIG. 9 is an elevational view of the system shown in FIGS. 8A-B, showing one mode of operation in which the cushion conversion machine produces packaging cushioning by drawing fan-folded sheet stock material from one of the two sheet stock supports;

FIG. 10A is a perspective view of the system shown in FIGS. 8A-B, wherein the supply structure is being rotated to present a freshly-loaded support to the machine;

FIG. 10B is similar to FIG. 10A, except taken at a 90° offset from the view shown in FIG. 10A to show the freshly-loaded support; and

FIG. 11 is similar to FIG. 9, except showing another mode of operation in which the cushion conversion machine produces packaging cushioning by drawing fan-folded sheet stock material simultaneously from both of the sheet stock supports.

### DETAILED DESCRIPTION OF THE INVENTION

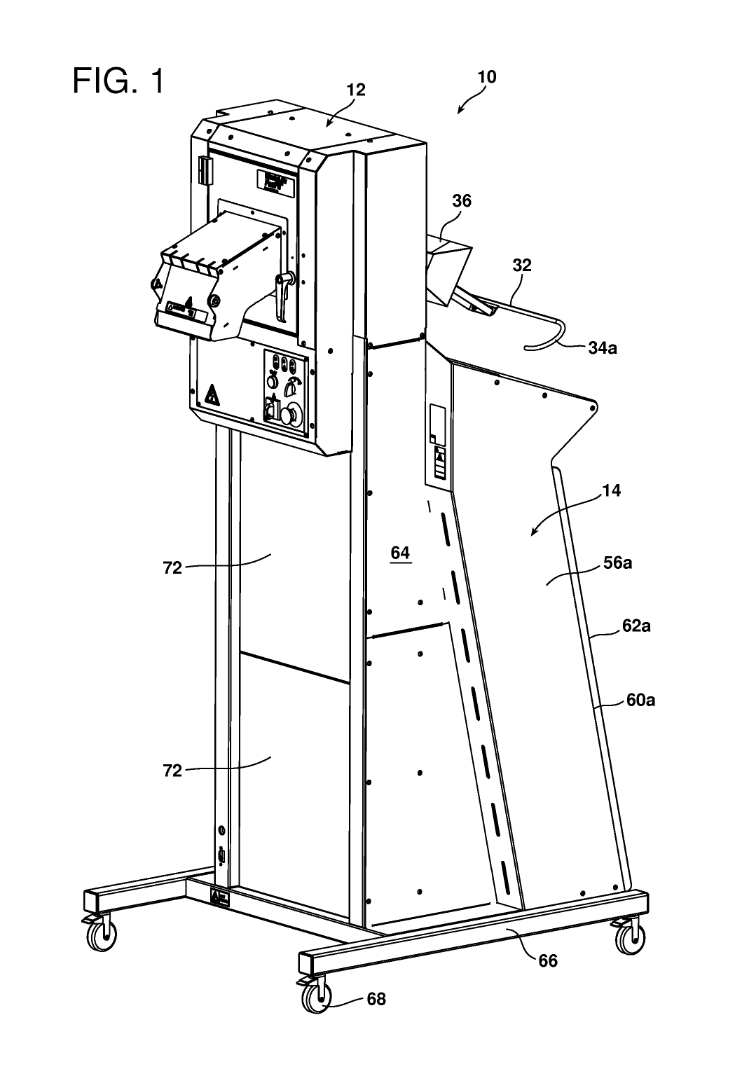

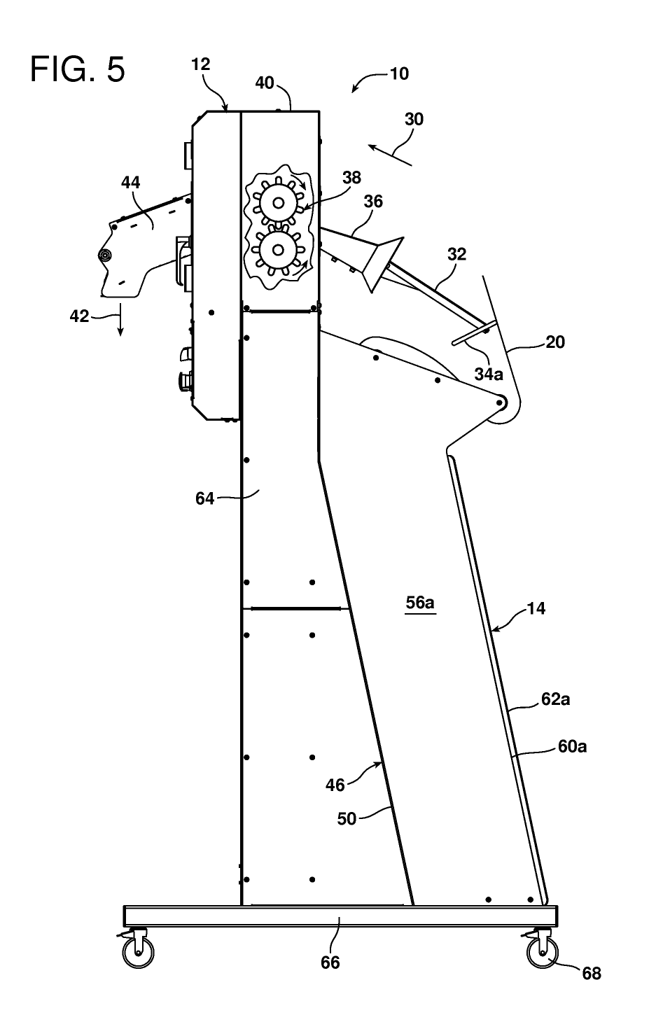

FIGS. 1-6 illustrate a system 10 for producing packaging cushioning, which generally includes a cushion conversion machine 12 and a supply structure 14 for a supply 16 of fan-folded sheet stock material 20. In the illustrated embodiment, the supply 16 is in the form of a stack, and includes five separate bundles 18, indicated as bundles 18a-18e, of fan-folded sheet stock material 20, which may be connected together, e.g., via the application of two-sided adhesive tape or the like, with the trailing end of one bundle being adhered to the leading end of an adjacent bundle (i.e., the next bundle below) in the stack 16. Thus, for instance, the trailing end (not shown) of bundle 18a may be connected to the leading end (not shown) of bundle 18b, etc. A greater or lesser number of bundles may be included in stack 16, i.e., greater than five or less than five. In addition, as an alternative to a connected stack of bundles 18, stack 16 may comprise a single, relatively large bundle.

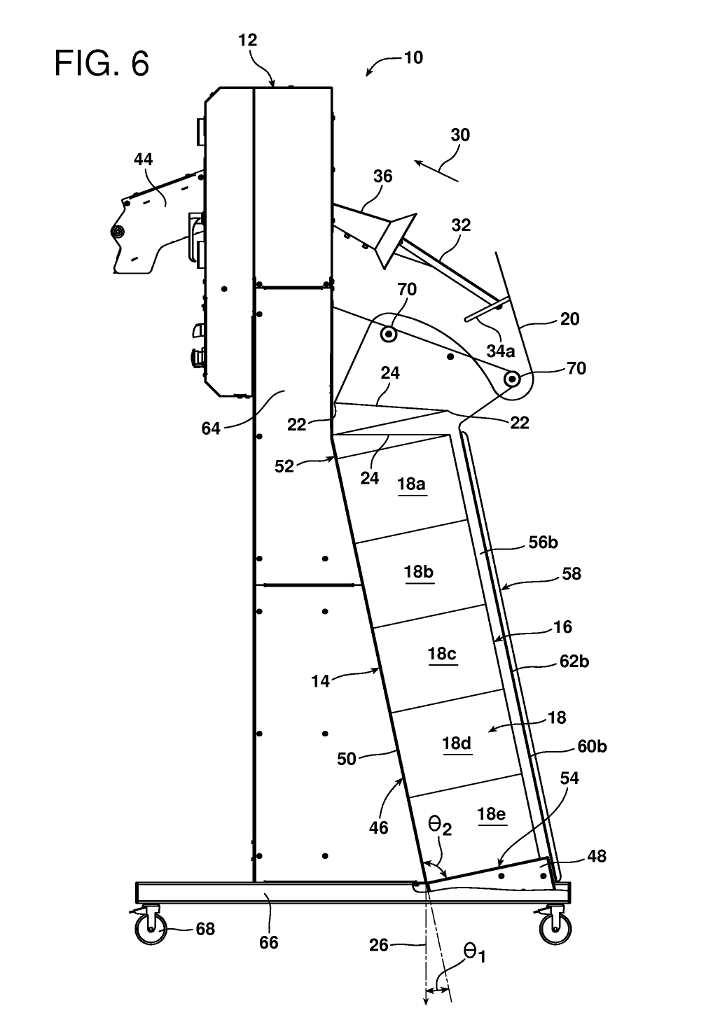

Sheet stock material 20 may comprise any type of material desired for use in packaging cushions, such as paper, e.g., kraft paper, fiberboard, thermoplastic film, etc., including recycled forms of the foregoing materials, as well as combinations thereof, e.g., laminated paper, coated paper, composite paper, etc. As shown in FIG. 6, sheet stock material 20 is in the form of a fan-folded, continuous web, with a series of alternating, transverse folds 22 that form a sequence of superimposed sheets 24 joined together by the folds 22. This allows the material 20 to be formed into parallelepiped-shaped bundles 18 as shown, which may be arranged as a stack 16 in supply structure 14, wherein the superimposed sheets 24 are compressed against one another by force of gravity, which acts in the vertical direction 26, i.e., along a ray extending radially inwards towards the center of the earth.

The fan-folding of the sheet stock material 20 may be accomplished by a “folder” mechanism, e.g., as manufactured and sold by B. Bunch Co. Inc., of Phoenix, Ariz. Such a mechanism is commonly used to fan-fold items such as forms, labels, and tickets. The resultant joined sheets 24 may have any desired shape, e.g., square, rectangular, etc., with any desired dimensions, e.g., a width dimension (along the transverse direction of folds 22) ranging from 6 to 30 inches, and a depth dimension ranging from 6 to 12 inches.

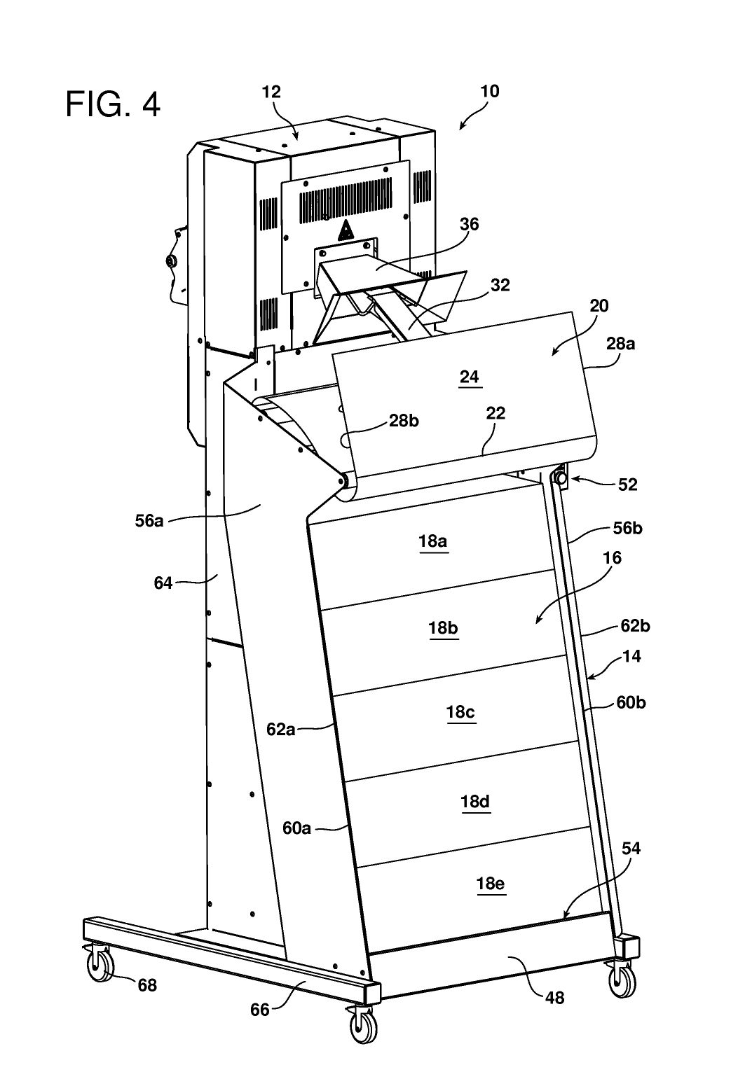

Cushion conversion machine 12 may be any conventional machine for making packaging cushioning from sheet stock material, including the PackTiger® cushioning machine, FasFil® void-fill machine, and FasFil® EZ™ void-fill machine, all of which are commercially available from Sealed Air Corporation of Elmwood Park, N.J. The machine 12 generally operates by folding and crumpling the fan-folded sheet stock material 20 to create packaging cushioning. The sheet stock material 20 is in the form of a continuous web, and is typically flat as it is withdrawn from stack 16. That is, each sheet 24 of the sheet stock web 20 has a generally planar shape, and is bounded between a pair of transverse folds 22 across the width of the web 20, and is also bounded between opposing lateral edges 28a, b of the web (FIGS. 4 and 6). The web 20 is supplied to machine 12 along a process path generally indicated by arrow 30, which may be referred to as the longitudinal (or ‘machine’) direction 30, to which the folds 22 in the web are transverse.

The machine 12 converts the web 20 from its fan-folded configuration to one in which the lateral edges 28a, b are inwardly-curled along the longitudinal direction 30, by causing the lateral edges 28a, b to converge towards one another. This is accomplished by directing the web around forming frame 32, which may comprise a pair of inwardly curved arms 34a, b, and also through forming chute 36, from which forming frame 32 extends. The spacing between inwardly-curved arms 34a, b is typically less than the width of web 20, and the width of forming chute 36 is typically less than both the width of web 20 and the spacing between arms 34a, b. In this manner, by directing the web 20 along machine direction 30, the lateral edges 28a, b of the web are forced to curl longitudinally and inwardly as the web wraps around the forming frame 32, followed by further convergence as the web travels through the more narrow forming chute 36.

Machine 12 may further include a pair of counter-rotating crumpling gears 38 located within a housing 40 of the machine, through which the web 20 travels after the lateral edges 28a, b are curled inward and converged together on forming frame 32 and in forming chute 36. The crumpling gears 38 crumple the converged web, which completes the conversion of the fan-folded sheet stock material 20 into packaging cushioning, schematically indicated at 42 as it egresses machine 12 via exit chute 44. Relative to the flat web 20, the finished cushioning material 42 has a reduced width and an increased thickness.

The crumpling gears 38 may be driven, i.e., rotationally powered by a motor or the like (not shown), to not only effect crumpling, but also to effect the movement of the web through the machine 12. The machine 12 may further include a cutting device (not shown), e.g., located within housing 40, in order to cut the cushioning material 42 into desired lengths to form individual cushioning pads. The desired length of the pads may vary depending on the intended application of the cushioning pads. For example, the cushioning pads may be used as dunnage, by positioning them between the inside surfaces of a box or other container and merchandise disposed in the container to protect the merchandise during shipping, handling, storing, and the like. Therefore, the desired length may be at least partially based on the size of the container and merchandise and/or the packaging technique (e.g., cross-cross, coil and multi-pad techniques) used to cushion and/or block and brace the merchandise in the container.

Supply structure 14 is positioned relative to machine 12 to supply thereto the fan-folded sheet stock material 20 for conversion thereof into packaging cushioning 42. Supply structure 14 generally comprises a support 46, which may include a base 48 and a riser 50 extending upwardly from the base. In the illustrated embodiment, the riser 50 extends upwardly from base 48 and towards machine 12. On other embodiments, the riser 50 could extend upwardly from base 48 and away from machine 12.

Base 48 and riser 50 are structured and arranged to cooperatively accommodate the stack 16 of fan-folded sheet stock material 20 in a load-bearing manner, and such that the sheet stock material 20 is supplied, e.g., in the form of a continuous web as described above, to cushion conversion machine 12 from the top 52 of the stack 16, wherein the sheets 24 are successively pulled from the top 52 of the stack 16 and into the machine via the folds 22 that join the sheets 24 together. The bottom 54 of the stack, including any support materials for the stack 16 and/or bottom-most bundle 18e (e.g., sleeves or boxes in which the bundles are contained), is supported by base 48.

In the illustrated embodiment, support 46 may be inclined, e.g., such that riser 50 is inclined at an angle θ₁ relative to vertical, i.e., the vertical direction 26. In this manner, stack 16 of fan-folded sheet stock material 20 may also be inclined at angle θ₁, whereby, the stack 16 is urged against riser 50 by force of gravity, which acts in vertical direction 26.

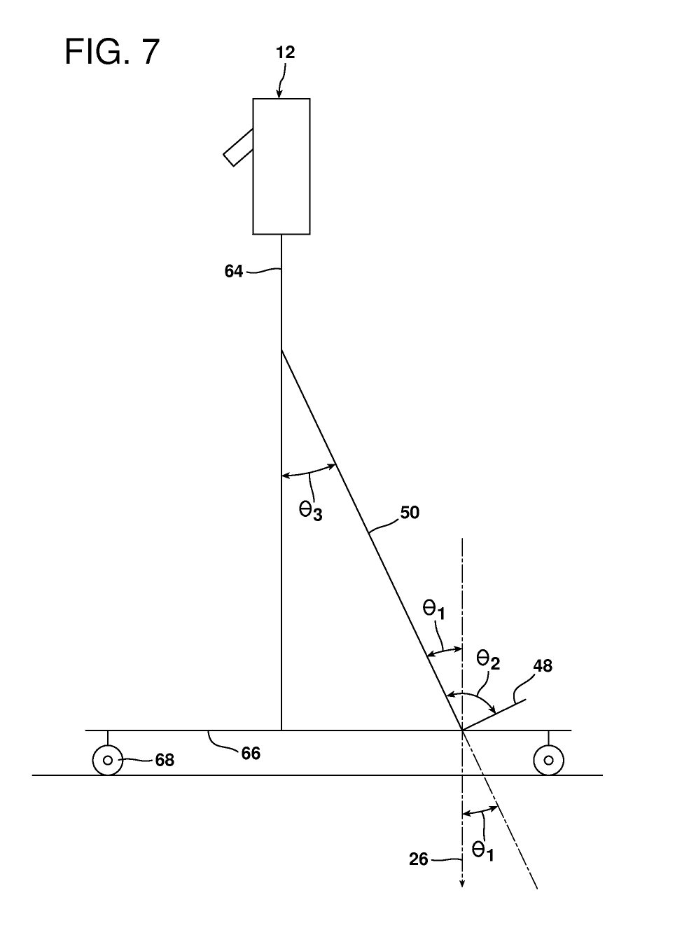

FIG. 7 is a schematic representation of some of the structural components of system 10 that are shown in the embodiment of FIG. 6. Given that gravity acts in the vertical direction 26 and riser 50 is inclined at angle θ₁ to vertical direction 26, one portion of the weight of stack 16 is urged against riser 50 while another portion is urged against base 48, with the relative amounts of such weight portions being dependent upon the degree of angle θ₁ from vertical 26. In the illustrated embodiment, angle θ₁ is acute. Thus, the greater the angle θ₁ relative to vertical 26, the greater will be the portion of the weight of stack 16 that is urged against riser 50, and the less of such weight portion that will be urged against base 48. Conversely, the greater the supplementary (obtuse) angle to angle θ₁, the lesser will be the portion of the weight of stack 16 that is urged against riser 50, and the more of such weight portion that will be urged against base 48. The angle between the riser 50 and vertical 26 may, in general, range from greater than 0° to less than 180°. With reference to angle θ₁ shown in FIGS. 6-7, which is acute, such angle may range from greater than 0° to less than 90°, such as greater than 5° to less than 45°, greater than 10° to less than 20°, etc. As a corollary, the supplementary angle to angle θ₁ may range from greater than 90° to less than 180°.

Advantageously, by supporting stack 16 at an angle, e.g., angle θ₁, relative to vertical, no further mechanical retention mechanism is needed, which greatly eases the process of loading the stack into the supply structure 14, inasmuch as the stack 16 may be loaded by simply setting the stack onto the support 46 with substantially no further action being required. Thus, the supply structure 14 may consist essentially of the support 46. This is in contrast to a supply structure arrangement wherein the stack is vertically oriented, which requires mechanical retention devices to prevent the stack from toppling over, but makes the loading process more difficult and increases the cost and complexity of the supply structure.

If desired, supply structure 14 may include a pair of spaced-apart lateral supports 56a, b, which may be positioned adjacent to the primary or load-bearing support 46 (in FIG. 6, lateral support 56a has been removed in order to show stack 16 in supply structure 14). If included, the lateral supports 56a, b are spaced sufficiently apart to accommodate therebetween the stack 16 of fan-folded sheet stock material 20, and serve to provide lateral stability thereto when contained in supply structure 14. The lateral supports 56a, b may each be in the form of unitary panels, as shown, or may take the form of one or more discrete rods, bars, slats, etc. Further, the lateral supports 56a, b may be supported independently of support 46, or may be integral therewith, e.g., attached thereto as shown.

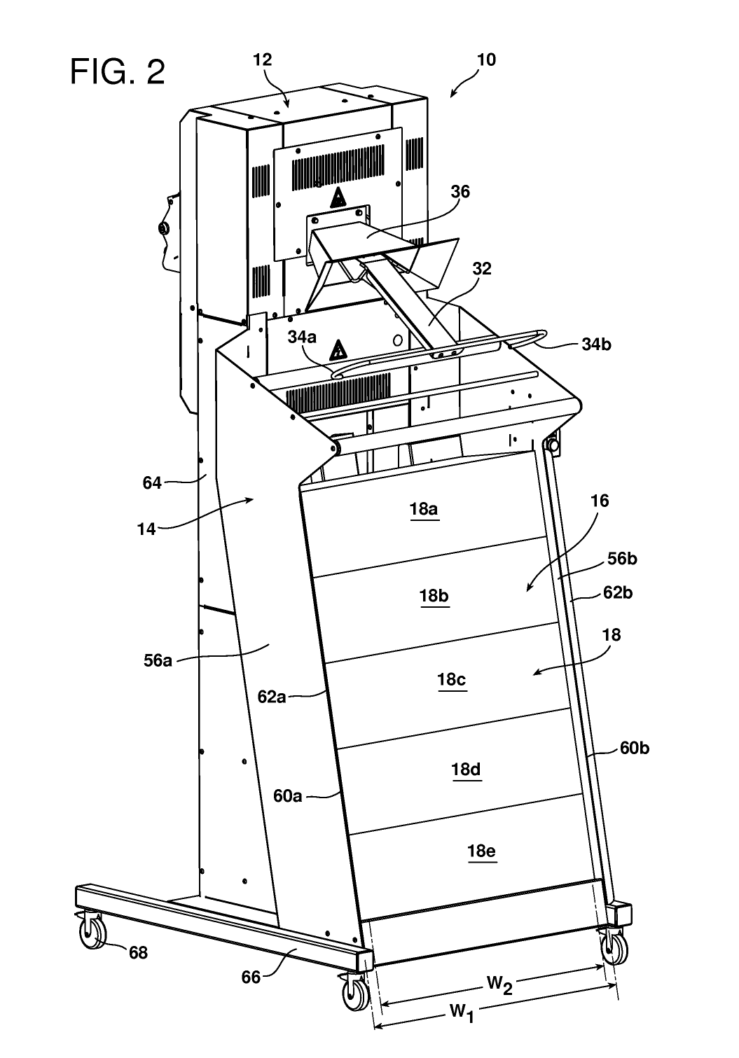

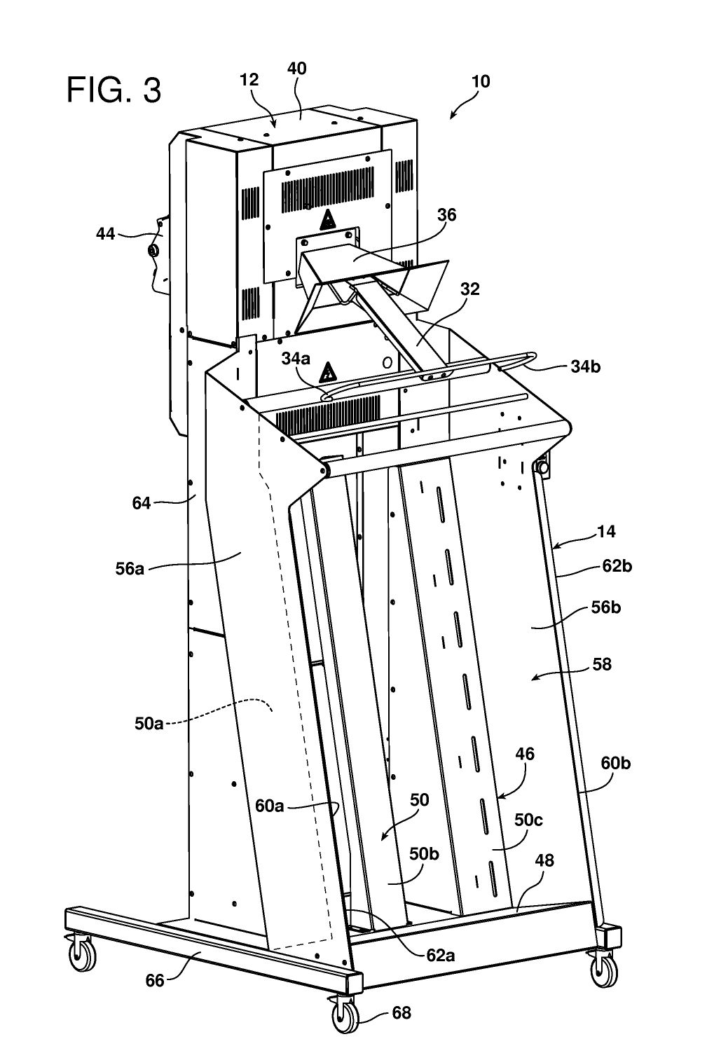

In those embodiments in which lateral supports 56a, b are included, the supply structure 14 may consist essentially of primary/load-bearing support 46 and lateral supports 56a, b. As perhaps best shown in FIG. 3, support 46 and lateral supports 56a, b may define three sides of the resultant supply structure 14, with an opening 58 being defined between opposing distal edges 60a, b of respective lateral supports 56a, b. Opening 58 has a width W₁, wherein such width W₁ is at least as great as a full width W₂ of the stack 16 of fan-folded sheet stock material 20 (FIG. 2), such that the stack 16 may be loaded onto load-bearing support 46 by moving the full width W₂ of the stack 16 through the opening 58 without the need to further manipulate the stack, e.g., such that substantially no tilting, angling, rotating, etc. of the bundles 18 is required. Thus, for those embodiments in which lateral supports 56a, b are included in supply structure 14, loading of the stack 16, e.g., via bundles 18, into the structure 14 is much easier relative to a vertically oriented structure, inasmuch as the stack need only be set and/or slid into place in structure 14.

For those embodiments in which support 46 is inclined at an angle to vertical, opening 58 for stack 16 may include substantially no mechanical retention devices. Instead, the angle θ₁ of riser 50 ensures that some of the weight of the stack 16 is borne by riser 50 and some is borne by base 48, which provides a stable support for the stack without the need for a mechanical retention device at opening 58. When utilized, lateral supports 56a, b provide protection from incidental lateral contact with the stack, e.g., by a person, moving object, air movement, etc., some or all of which can occur in the use (e.g., packaging) environment. If desired, opening 58 may include a pair of outwardly-flared guide brackets 62a, b, which may extend from respective distal edges 60a, b as shown, in order to further facilitate the loading of bundles 18 into the supply structure 14.

Riser 50 may comprise a single component or two or more separate components. In the illustrated embodiment, riser 50 includes three separate components, indicated as riser components 50a-c in FIG. 3. As may be appreciated, a single unitary structure, e.g., extending across the width W₁ of supply structure 14 (FIG. 2), could, instead, be employed for riser 50.

With reference to FIGS. 6 and 7, base 48 may be oriented at an angle θ₂ relative to riser 50, wherein angle θ₂ ranges from greater than 0° to less than 180°, such as greater than 30° to less than 150°; greater than 60° to less than 120°; or greater than 80° to less than 100°. When angle θ₂ is approximately 90° as shown, bundles 18a-e are aligned in stack 16 on the support 46 as shown in FIG. 6, i.e., such that the outer surfaces thereof (nearest opening 58) are substantially co-planar. In contrast, when angle θ₂ is obtuse, bundles 18a-e will be stacked on support 46 in a non-aligned manner, i.e., such that the outer surfaces thereof (nearest opening 58) are off-set from one another in separate planes in a ‘stair-step’ manner. Either type of stack configuration may be employed in accordance with the present invention.

System 10 may further include a stand 64 to which cushion conversion machine 12 is mounted. Stand 64 may be aligned in a substantially vertical orientation, i.e., in alignment with vertical direction 26, as perhaps best shown in FIGS. 6-7. The riser 50 of support 46 may thus be oriented at an angle relative to stand 64, which may range from greater than 0° to less than 180°. In FIG. 7, the acute form of such angle is identified as angle θ₃, which may range from greater than 0° to less than 90°, such as greater than 5° to less than 45°, greater than 10° to less than 20°, etc. As a corollary, the supplementary angle to angle θ₃ may range from greater than 90° to less than 180°. As may be appreciated, for those embodiments wherein stand 64 is aligned with the vertical direction 26 (as illustrated), angle θ₃ will be substantially the same as angle θ₁.

Stand 64 and supply structure 14 may be independent from one another or, as illustrated, may be attached together, e.g., in the form of a substantially integrated apparatus as shown, which may be mounted on a platform 66 with wheels 68 to allow the system 10 to be moved as desired.

With reference to FIG. 6, it may be seen that supply structure 14 may include one or more guide rollers 70 to direct the sheet-stock material 20 from the stack 16 and into machine 12 via forming frame 32 and forming chute 36.

System 10 may further include a visual indicator relative to an amount, i.e., height, of stack 16 of fan-folded sheet stock material 20 contained in supply structure 14. Such an indicator may be useful to an operator of system 10, who generally works facing the exit chute 44, so that he/she may know when the supply of fan-folded sheet stock material 20 in supply structure 14 is nearing exhaustion and will have to be replenished with a new stack 16 of bundles 18. With reference to FIG. 1, it may be seen that stand 64 may include one or more, e.g., a pair, as illustrated, of front panels 72. A visual indicator as to the amount of sheet stock supply 20 in structure 14 may be effected by constructing the panels 72 from a transparent material, such as polycarbonate or the like. Alternatively or in addition, such visual indicator may be provided by including a series of indicator slots 74 in riser components 50a and/or 50c (FIGS. 1 and 3), which may extend along a portion of, or, as illustrated, substantially the entire length of, such riser components, and thereby permit a view of the supply of bundles 18 therebehind in supply structure 14.

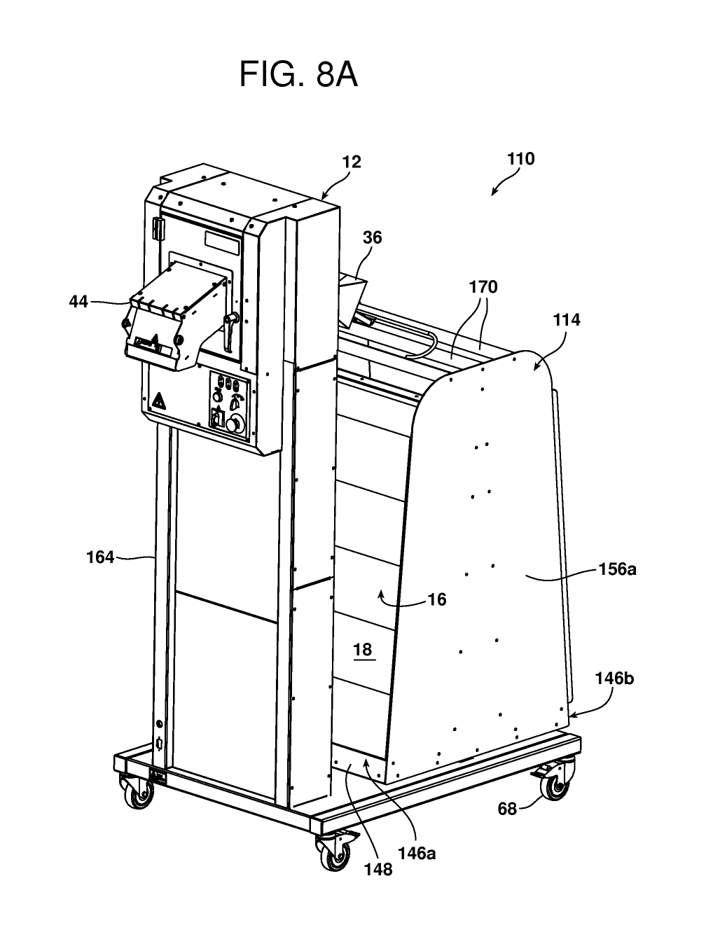

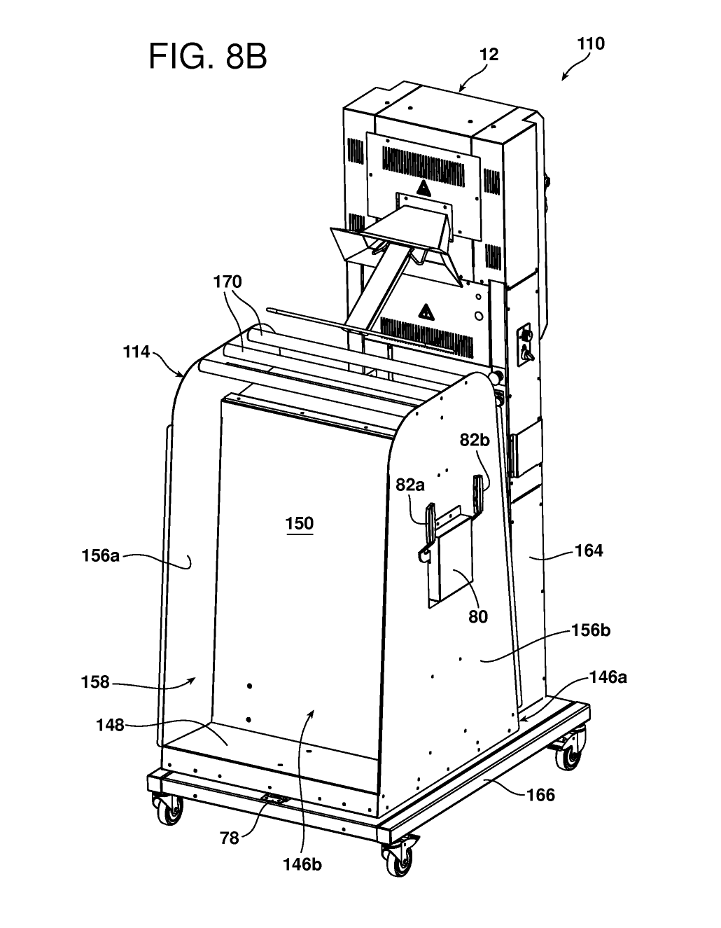

With reference now to FIGS. 8-11, an alternative system 110 will be described, wherein like reference numbers refer to like elements as described hereinabove. As with system 10, system 110 is adapted to produce packaging cushioning, and comprises a cushion conversion machine, such as conversion machine 12 as described above, as well as a supply structure 114. Like supply structure 14, supply structure 114 is adapted to contain a supply 16 of fan-folded sheet stock material 20. Similarly, supply structure 114 is positionable relative to machine 12 to provide thereto the fan-folded sheet stock material 20 for conversion thereof into packaging cushioning 42, wherein the supply structure 114 comprises a support 146.

Similar to support 46, support 146 is load-bearing, and includes a base 148 and a riser 150 extending upwardly from the base 148, with the base and riser 148, 150 being structured and arranged to cooperatively accommodate the supply 16 of fan-folded sheet stock material 20 in the form of a stack, e.g., stacked bundles 18. For example, as described above with respect to support 46, support 146 may be structured and arranged such that the sheet stock material 20 is supplied to cushion conversion machine 12 from a top of the stack 16 and a bottom of the stack is supported by base 148. Further, riser 150 may be inclined at an angle relative to vertical, as also described above, such that the stack 16 is inclined at such angle and thus urged against riser 150 by force of gravity.

Unlike supply structure 14, however, supply structure 114 includes two or more supports 146, e.g., a pair of supports 146a and 146b as shown. This arrangement provides system 110 with the ability to be operated in at least two modes.

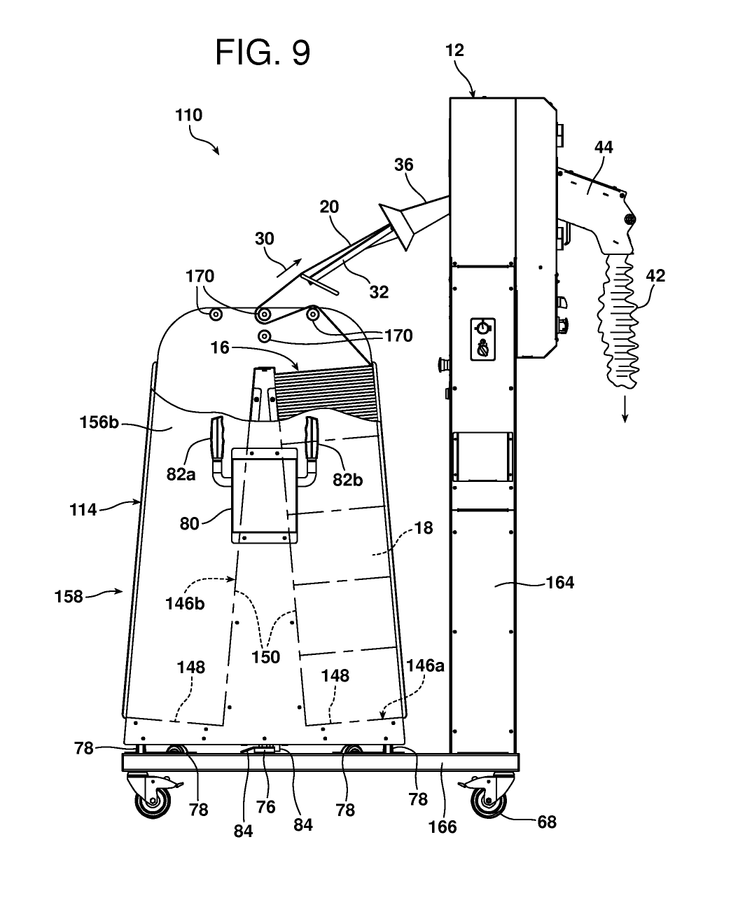

A first mode of operation is shown in FIGS. 8-10. As shown in FIGS. 8-9, support 146a is positioned relatively closest to machine 12 and contains a stack 16 of fan-folded sheet stock material 20, in the form of stacked and connected bundles 18. Support 146a is thus positioned to provide machine 12 with the sheet stock material for conversion thereof into packaging cushioning. Support 146b, on the other hand, is positioned relatively farther from machine 12, and is empty, i.e., contains no sheet stock material. When in the position shown in FIGS. 8-9, support 146b is optimally situated to be loaded with a fresh stack of sheet stock material. In such position, for example, the load-opening 158 into support 146b faces the rear of system 110, i.e., away from machine 12, so that there will be little or no interference from machine 12 or stand 164 to impede the loading process. Thus, in FIG. 9, as the sheet-stock material 20 is being fed into machine 12 from stack 16 on support 146a for conversion into cushioning 42, the opposing support 146b is ready to be loaded with a fresh stack of sheet-stock material. In this manner, when the stack 16 on support 146a becomes depleted, the newly-loaded stack on support 146b will be ready for supply to machine 12.

In accordance with an advantageous embodiment of the invention, therefore, system 110 may be structured and arranged such that supply structure 114 and machine 12 are relatively movable, i.e., are movable relative to one another. Such relative movability allows at least one of the supports 146, e.g., support 146b, to be loaded with fan-folded sheet stock material 20 while at least one other of the supports, e.g., support 146a, is positioned to supply previously-loaded fan-folded sheet stock material to machine 12. Numerous arrangements are possible such as, e.g., rotatable movability, translatable movability, etc., in a horizontal plane, vertical plane, or any plane therebetween.

One embodiment of rotatable movability is illustrated in FIGS. 8-10, wherein system 110 may further include a stand 164, to which machine 12 may be mounted. Stand 164 and supply structure 114 may be attached together via platform 166, e.g., such that the stand and supply structure form a substantially integrated apparatus as shown. In this embodiment, supply structure 114 is rotatably mounted to platform 166. Stand 164 may be rotatably or non-rotatably mounted to platform 166. Similarly, machine 12 may be rotatably or non-rotatably mounted to stand 164.

As shown perhaps most clearly in FIG. 9, supply structure 114 may be rotatably mounted to platform 166 via vertical axle 76, and supported by two or more castor wheels 78. Axle 76 and castor wheels 78 may be secured to platform 166, with castor wheels 78 having rotational axes that are aligned with a ray extending outwardly from axle 76. In this manner, the castor wheels 78 support the horizontal rotation of supply structure 114 on axle 76. In the illustrated embodiment, six castor wheels 78 are employed.

Supply structure 114 may further include an actuator 80, having a pair of handle members 82a, b, to facilitate manual rotation of the supply structure 114 by an operator of system 110. A latch mechanism 84 may also be included to secure supply structure 114 in the operating position shown in FIG. 9, e.g., by providing a non-movable connection between supply structure 114 and platform 166 such that the supply structure is prevented from rotating on axle 76 when the latch mechanism 84 is engaged, as shown in FIG. 9. One or both handle members 82a, b may be operatively, e.g., mechanically, connected to latch mechanism 84 such that the latch mechanism 84 can be caused to disengage, and thereby release the supply structure 114 so that it can be rotated on axle 76.

Like supply structure 14, supply structure 114 may include a pair of lateral supports 156a, b, which together define an opening 158 into each of the load-bearing supports 146a, b. As described above, bundles 18 of the fan-folded sheet-stock material 20 may be loaded into the supports 146a, b through such openings 158. Actuator 80 may be mounted, e.g., on lateral support 156b as shown.

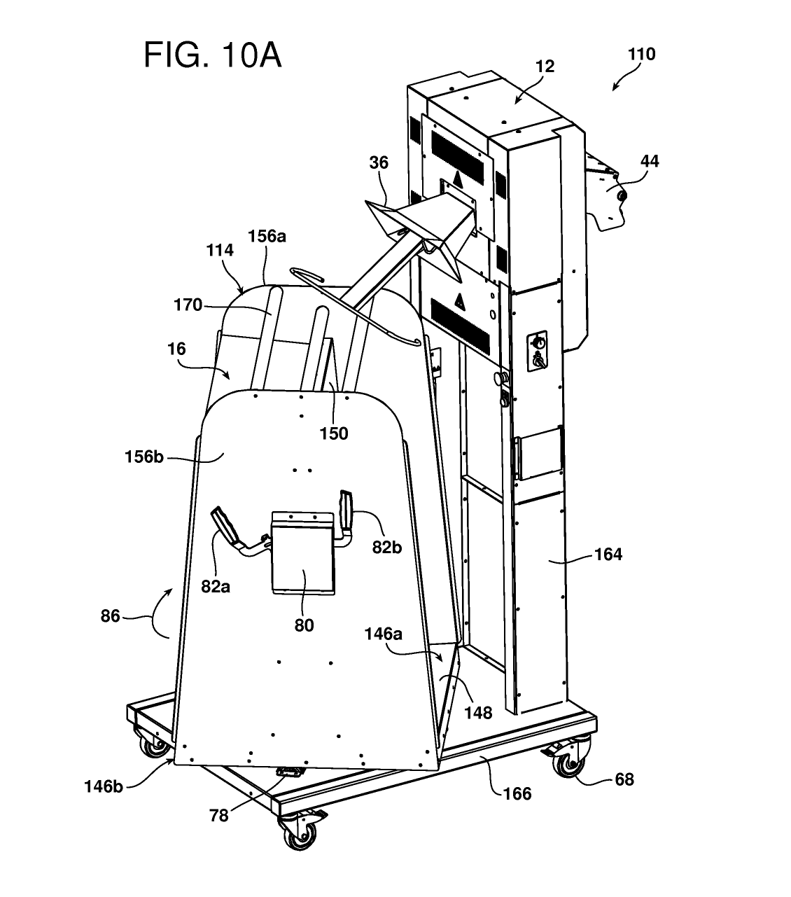

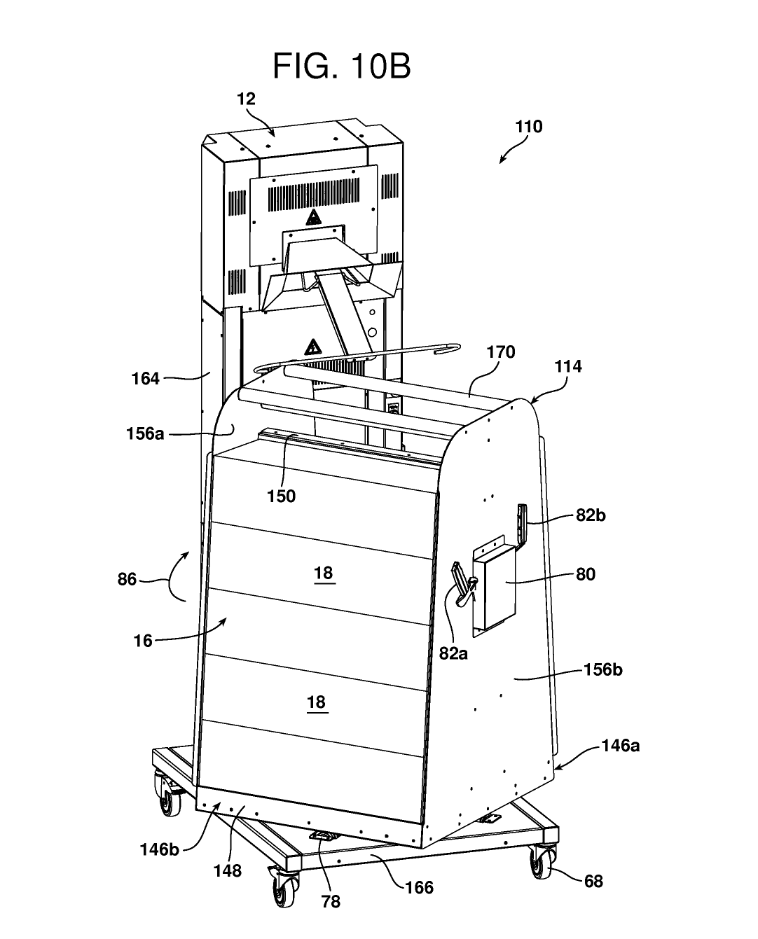

Accordingly, with collective reference to FIGS. 9-10, the currently-described mode of operation of system 110 will be completed. In FIG. 9, the fan-folded sheet-stock material 20 is being fed into machine 12 from stack 16 on support 146a for conversion into cushioning 42. In this regard, guide rollers 170 may be included in supply structure 114 to facilitate the process of directing the web 20 of sheet-stock material 20 in machine direction 30, around forming frame 32, and into forming chute 36 as shown. The opposing support 146b is empty and in position to be loaded with a fresh stack of sheet-stock material through rear-facing opening 158. Thus, while the machine 12 produces cushioning 42 from fan-folded material 20 provided by support 146a, the operator of system 110 can load opposing support 146b with a fresh stack of material 20. For example, during the operation of machine 12 and supply thereto of fan-folded sheet stock material 20 from stack 16 on support 146a (FIG. 9), the operator of system 110 may load opposing support 146b with a fresh stack 16 of five (5) bundles 18 of fan-folded sheet stock material 20; the result of such action is shown in FIGS. 10A-B. In this manner, when the stack 16 on support 146a becomes depleted, the newly-loaded stack on support 146b will be ready for supply to machine 12.

FIGS. 10A-B illustrate the depletion of stack 16 on support 146a, and the fast and convenient transition made possible by supply structure 114 to allow machine 12 to resume cushion-making production following such depletion (FIGS. 10A-B are two separate views, spaced apart by 90°, of the same transitory depiction of supply structure 114). Immediately following the depletion of the stack 16 on support 146a, the operator of system 110 (not shown) grasped the handle members 82 of actuator 80 to begin the process of moving the freshly-loaded support 146b into the supply position formerly occupied by support 146a (shown in FIG. 9). The operator may use one hand, e.g., the left hand, to move handle member 82a to the ‘unlatch position’, which, as shown in FIGS. 10A-B, may be at an angle to the generally vertically-oriented ‘latch position’ shown in FIG. 9. Such angle may range, e.g., from 0 to 90 degrees from vertical, such as about 20 degrees, 30 degrees, 40 degrees, etc., from vertical. As depicted, the unlatch position is about 45 degrees from vertical. By moving the handle member 82a to the unlatch position, latch mechanism 84 disengages and releases the supply structure 114 so that it is free to rotate on axle 76. The operator may use the other hand, e.g., the right hand, to grasp handle member 82b and exert a rotational force thereon such that the entire supply structure 114 rotates in the direction of arrow 86. The rotation along direction 86 may continue until the supply structure 114 has rotated 180 degrees, such that the supports 146a, b switch positions, with the loaded support 146b in the supply position formerly occupied by support 146a (FIG. 9) and the empty support 146a in the loading position formerly occupied by support 146b (FIG. 9). Once the supply structure 114 is in such position, the handle member 82a may be returned to its vertically-oriented latch position, which causes the latch mechanism 84 to engage and thereby secure the structure 114 in place by preventing further rotation. The fan-folded material 20 may then be fed into the machine 12 from the top-most bundle 18 in the stack 16 to once again produce cushioning 42.

The empty support 146a can then be loaded with a fresh stack 16 and the transition process shown in FIGS. 10A-B can be repeated once the support 146b is depleted. In this instance, the operator could actuate handle member 82b to release the latch mechanism 84, and push on handle member 82a to effect rotation of the supply structure 114 in the opposite direction as direction 86.

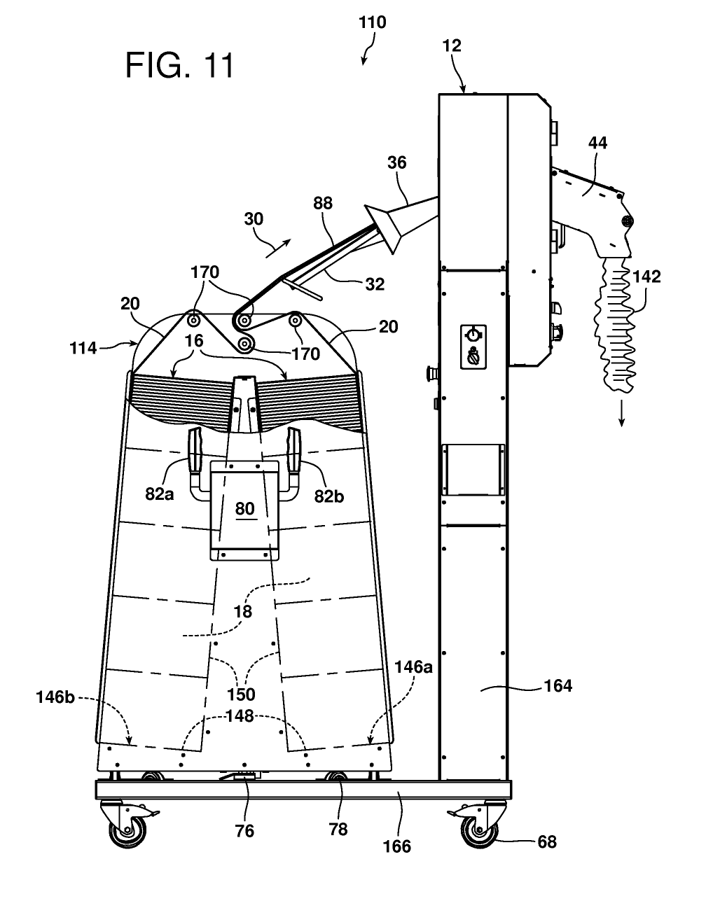

With reference now to FIG. 11, a second mode of operation of system 110 will be described, wherein supply structure 114 is configured to simultaneously provide fan-folded sheet stock material 20 to machine 12 from both supports 146a, b, e.g., in the form of two or more superposed webs 88 of the sheet stock material. In this mode of operation, both of supports 146a, b contain a stack 16 of fan-folded sheet stock material 20, e.g., in the form of stacked and connected bundles 18 as shown. As depicted in FIG. 11, five (5) such bundles 18 are contained on each support 146a, b, and fan-folded sheet-stock material 20 from stack 16 on each support is being fed simultaneously into machine 12 for conversion into cushioning 142. Guide rollers 170 of supply structure 114 may be configured to facilitate the process of bringing the fan-folded material 20 from each support 146a, b together to form superposed webs 88, and then directing the superposed webs in machine direction 30, onto forming frame 32, and into forming chute 36 as shown.

The resultant cushioning material 142 produced by system 110 in the second mode of operation is thus a two-ply cushioning product vs. the one-ply cushioning product 42 produced by system 110 in the first mode of operation (as depicted in FIG. 9). Two-ply cushioning is sometimes desired, e.g., when packaging heavier objects. Thus, a further advantage of supply-structure 114 is that it allows one-ply or two-ply cushioning to be produced with no additional equipment requirements, and with minimal operator manipulation to switch between the two modes of operation.

Although supply structure 114 has been illustrated and described with two supports 146 (i.e., supports 146a, b), a greater number may be employed, e.g., 3, 4, 5, etc., as desired.

The foregoing description of preferred embodiments of the invention has been presented for purposes of illustration and description. It is not intended to be exhaustive or to limit the invention to the precise form disclosed, and modifications and variations are possible in light of the above teachings or may be acquired from practice of the invention.

What is claimed is:

1. A system for producing packaging cushioning, comprising:
A. a cushion conversion machine; and
B. a supply structure for a supply of fan-folded sheet stock material, said supply structure being positioned relative to said machine to provide thereto the fan-folded sheet stock material for conversion thereof into packaging cushioning, said supply structure including two or more supports, each of said supports comprising a base and a riser extending upwardly from said base, said base and said riser being structured and arranged to cooperatively accommodate a stack of the fan-folded sheet stock material.

2. The system of claim 1, wherein said supply structure and said machine are relatively movable.

3. The system of claim 2, wherein said relative movability allows at least one of said supports to be loaded with fan-folded sheet stock material while at least one other of said supports is positioned to provide previously-loaded fan-folded sheet stock material to said machine.

4. The system of claim 2, wherein said relative movability is selected from at least one of rotatable movability and translatable movability.

5. The system of claim 1, wherein said supply structure is configured to simultaneously provide fan-folded sheet stock material from said supports to said machine.

6. The system of claim 5, wherein said simultaneous supply of fan-folded sheet stock material is in the form of two or more superposed webs of the sheet stock material.

7. The system of claim 1, wherein said supports are structured and arranged such that the sheet stock material is supplied to said cushion conversion machine from a top of the stack and a bottom of the stack is supported by said base.

8. The system of claim 1, wherein said riser is inclined at an angle relative to vertical such that the stack of fan-folded sheet stock material is also inclined at said angle, whereby, the stack is urged against said riser by force of gravity.

9. The system of claim 1, further including a stand to which said machine is mounted.

10. The system of claim 9, wherein said stand and said supply structure are attached together.

11. The system of claim 10, wherein said stand and said supply structure form a substantially integrated apparatus.

12. A supply structure for a supply of fan-folded sheet stock material, said supply structure being positionable relative to a cushion conversion machine to provide thereto the fan-folded sheet stock material for conversion thereof into packaging cushioning, said supply structure including two or more supports, each of said supports comprising a base and a riser extending upwardly from said base, said base and said riser being structured and arranged to cooperatively accommodate a stack of the fan-folded sheet stock material.

13. The supply structure of claim 12, wherein said supply structure and said machine are relatively movable.

14. The supply structure of claim 13, wherein said relative movability allows at least one of said supports to be loaded with fan-folded sheet stock material while at least one other of said supports is positioned to supply previously-loaded fan-folded sheet stock material to said machine.

15. The supply structure of claim 13, wherein said relative movability is selected from at least one of rotatable movability and translatable movability.

16. The supply structure of claim 12, wherein said supports are structured and arranged to simultaneously supply fan-folded sheet stock material to said machine.

17. The supply structure of claim 16, wherein said simultaneous supply of fan-folded sheet stock material is in the form of two or more superposed plies of sheet stock material.

18. The supply structure of claim 12, wherein said supports are structured and arranged such that the sheet stock material is supplied to said cushion conversion machine from a top of the stack and a bottom of the stack is supported by said base.

19. The supply structure of claim 18, wherein said riser is inclined at an angle relative to vertical such that the stack of fan-folded sheet stock material is also inclined at said angle, whereby, the stack is urged against said riser by force of gravity.
